(19) United States
(12) Patent Application Publication
(10) Pub. No.: US 2011/0297663 A1
(43) Pub. Date: Dec. 8, 2011

(54) IMAGE HEATING DEVICE AND HEATER FOR USE IN THE DEVICE

(75) Inventor: Noriyuki Ito, Mishima-shi (JP)

(73) Assignee: CANON KABUSHIKI KAISHA, Tokyo (JP)

(21) Appl. No.: 13/149,033

(22) Filed: May 31, 2011

(30) Foreign Application Priority Data
Jun. 2, 2010 (JP) 2010-127344

(51) Int. Cl. H05B 1/00

(52) U.S. Cl. 219/216; 219/542

(57) ABSTRACT

An image heating device includes a cylindrical film; a heater contacted to an inner surface of the film, wherein the heater includes a substrate, a heat generating resistor provided on the substrate, and an insulating layer for covering the heat generating resistor and is contacted to the film; and a pressing member for pressing the film against the heater to form a nip, between itself and the film, in which a recording material carrying thereon an image is to be nip-conveyed. The heater includes an electroconductive layer, which is grounded, provided at a position between and remote from a film-side surface of the insulating layer and the heat generating resistor.

### FIELD OF THE INVENTION AND RELATED ART

The present invention relates to an image heating device and a heater for use in this image heating device.

In an image heating device of an image forming apparatus, particularly in the image heating device including a heating source using a ceramic substrate, an insulating layer for coating a heat generating resistor provided on the ceramic substrate functions as a capacitor in an equivalent circuit. When an AC voltage is applied to the heating source from a commercial power source in order to heat the heating source, the AC voltage is transmitted to a fixing nip through a fixing film.

A recording material is lowered in impedance when a water (moisture) content is increased. When the recording material lowered in impedance is nipped simultaneously in a transfer nip between a photosensitive drum and a transfer roller and in the fixing nip, the AC voltage applied to the fixing nip is transmitted to the transfer nip through the recording material, so that a transfer voltage in the transfer nip is fluctuated. The fluctuation in transfer voltage causes transfer non-uniformity, which appears on an image on the recording material as a stripe pattern (image density non-uniformity) with respect to a sub-scan direction (recording material conveyance direction). As a means for avoiding this phenomenon, a constitution in which the fixing nip is grounded through the capacitor and a resistor to reduce the AC voltage generated in the fixing nip has been proposed (Japanese Laid-Open Patent Application No. 2006-195003).

Part (a) of FIG. 5 is a schematic view of a heat-fixing device (image heating device) of a film heating type according to a conventional embodiment.

Part (a) of FIG. 5 is a plan view showing a schematic structure of a heater (heat generating member). A heater substrate 102 formed in an elongated thin plate shape with a ceramic material such as alumina includes a heat generating resistor 103, an electroconductive member 109 for applying a voltage to the heat generating resistor 103 and a coating glass 104 for insulating a commercial power source voltage to be applied to the heat generating resistor 103. With respected to temperature control by the application of the AC voltage to the heat generating resistor, e.g., a constitution in which heating control is effected so that a temperature of the heater is a predetermined temperature by using an unshown temperature detecting means while synchronizing a commercial power source frequency detecting circuit with the commercial power source is generally employed. A heater holder 105 as a heating member supporting member has rigidity and heat resistance. The heater holder 105 is provided with a groove, at its lower surface, in which the heater substrate 102 is engaged and fixedly supported along a longitudinal direction of the heater holder 105. On an exposed surface of the heater, a heat-resistant fixing film 106 is moved while being pressed and contacted by a pressing roller 107. In a fixing nip N formed between the pressing roller 107 and the fixing film 106 contacted to the heater, a recording material 108 on which an unfixed toner image is formed and carried is conveyed. The unfixed toner image is fixed on a surface of the recording material 108 by applying heat of the heat generating resistor 103 to the recording material 108 through the fixing film 106.

FIG. 6 is a schematic view of an image forming apparatus according to the conventional embodiment, wherein constituent members having the same functions as those in FIG. 5 are represented by the same reference numerals or symbols. A photosensitive drum 601 as an image bearing member includes a photosensitive layer at its surface. A transfer roller 602 supplies transfer electric charges to the recording material 108. An output from a transfer voltage generating portion 610 is applied to a transfer nip T between the photosensitive drum 601 and the transfer roller 602 through a resistor Rₜ. As a result, the unfixed toner image 604 is transferred onto the recording material 108 and then is nipped and conveyed to the fixing nip N while being carried on the recording material 108. In the fixing nip N, heat of the heat generating resistor 103 driven and controlled by CPU 60, and pressure by an unshown pressing means are applied simultaneously, so that the image is fixed.

Here, to the fixing film 106, in order to stabilize the image during the fixing (in order to prevent offset of the toner onto the fixing film), an output voltage from a fixing bias generating portion 605 is applied through bridging resistors 606 and 607 for ensuring insulating properties of the commercial power source and the fixing bias generating portion 605. Further, in order to reduce the influence of the AC voltage applied to the fixing nip on a transfer bias, the fixing nip is grounded through a capacitor 609 and a resistor 608 which provide a joint impedance lower than that of a path constituted by the recording material 108, the transfer roller 602 and the like.

However, in the above-described conventional embodiment, the fixing nip was grounded through the capacitor and the resistor, so that increases in the number of parts and in substrate area constituted a major factor in increase of cost. Further, in order to minimize the influence of the AC voltage fluctuation, there was a need to ground the fixing nip with low impedance but in the conventional embodiment, the fixing nip was connected to the fixing bias generating portion 605 and the transfer nip, so that there arose such a problem that it was difficult to optimize setting of constants which did not adversely affecting the fixing bias and the transfer nip.

### SUMMARY OF THE INVENTION

A principal object of the present invention is to provide an image heating device capable of suppressing a fluctuation in transfer voltage, with a simple constitution, caused by the influence of a voltage applied to a heater.

Another object of the present invention is to provide the heater for use in the image heating device.

According to an aspect of the present invention, there is provided an image heating device comprising:

a cylindrical film;

a heater contacted to an inner surface of the film, wherein the heater includes a substrate, a heat generating resistor provided on the substrate, and an insulating layer for covering the heat generating resistor and is contacted to the film; and

a pressing member for pressing the film against the heater to form a nip, between itself and the film, in which a recording material carrying thereon an image is to be nip-conveyed,

wherein the heater includes an electroconductive layer, which is grounded, provided at a position between and remote from a film-side surface of the insulating layer and the heat generating resistor.

According to another aspect of the present invention, there is provided a heater comprising:

a substrate;

a heat generating resistor provided on the substrate;

an insulating layer for covering the heat generating resistor; and

an electroconductive layer provided at a position between and remote from a surface of the insulating layer and the heat generating resistor.

According to another aspect of the present invention, there is provided an image heating device comprising:

a cylindrical film;

a heater contacted to an inner surface of the film, wherein the heater includes a substrate, a heat generating resistor provided on the substrate, and an insulating layer provided on the substrate at a surface opposite from a surface at which the heat generating resistor is provided on the substrate, and is contacted to the film; and

a pressing member for pressing the film against the heater to form a nip, between itself and the film, in which a recording material carrying thereon an image is to be nip-conveyed,

wherein the heater includes an electroconductive layer, which is grounded, provided at a position the substrate and insulating layer.

According to a further aspect of the present invention, there is provided a heater comprising:

a substrate;

a heat generating resistor provided on the substrate;

an insulating layer provided on the substrate at a surface opposite from a surface at which the heat generating resistor is provided on the substrate; and

an electroconductive layer provided at a position between the substrate and the insulating layer.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

Parts (a) and (b) of FIG. 1 are schematic views of an image heating device according to Embodiment 1 of the present invention.

Parts (a) and (b) of FIG. 2 are equivalent circuit diagrams of image forming apparatus, in which (a) is the equivalent circuit diagram in Embodiment 1 of the present invention, and (b) is the equivalent circuit diagram in a conventional embodiment.

Parts (a) and (b) of FIG. 3 are schematic views of an image heating device according to Embodiment 2 of the present invention.

FIG. 4 is an equivalent circuit diagram of an image forming apparatus according to Embodiment 3 of the present invention.

Parts (a) and (b) of FIG. 5 are schematic views of an image heating device according to the conventional embodiment.

FIG. 6 is a circuit structure diagram of an image forming apparatus according to the conventional embodiment.

FIG. 7 is a schematic view of an image forming apparatus.

### DESCRIPTION OF THE PREFERRED EMBODIMENTS

Hereinbelow, embodiments for carrying out the present invention will be described in detail based on Embodiments. However, dimensions, materials, shapes, relative arrangement and the like of constituent members or elements described in the following embodiments do not limit the present invention thereto unless otherwise specified.

### Embodiment 1

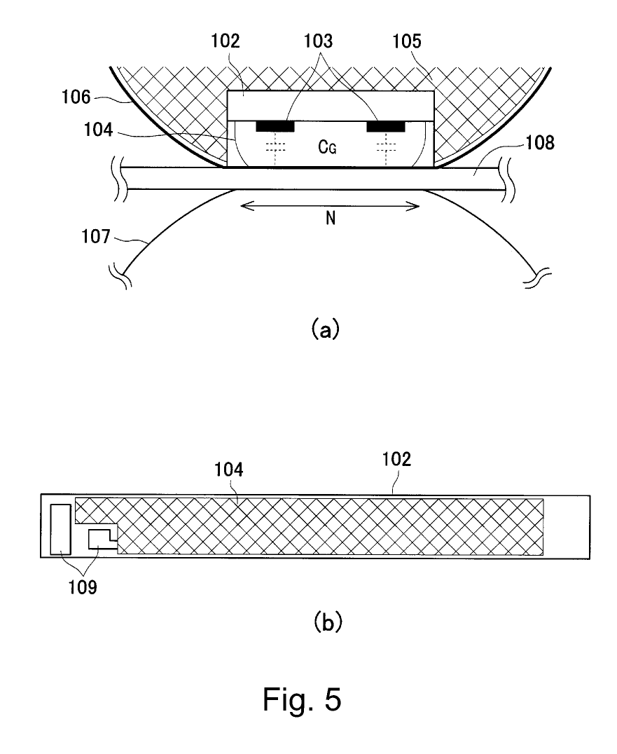

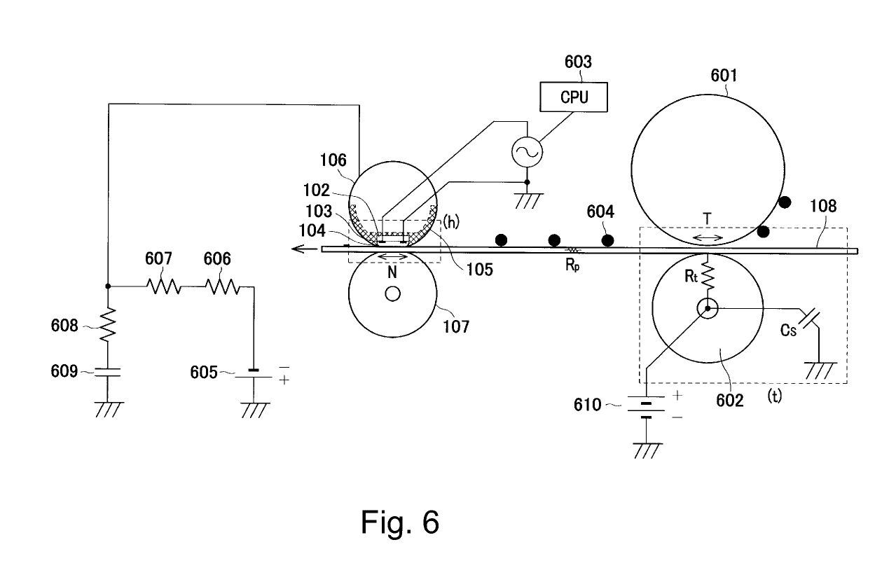

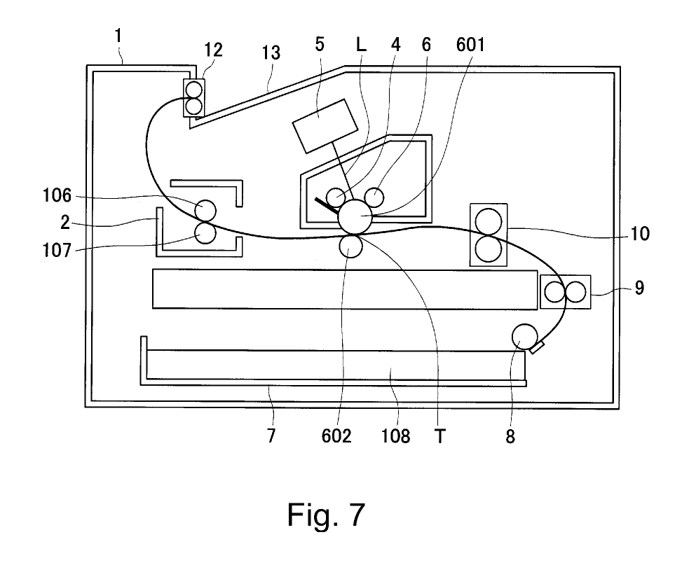

With respect to FIGS. 1, 2 and 7, an image heating device (heat-fixing device) according to Embodiment 1 of the present invention and an image forming apparatus including the image heating device will be described. Parts (a) and (b) of FIG. 1 are schematic views for illustrating a structure of the image heating device in this embodiment, wherein (a) is a schematic view and (b) is a plan view of a heat generating member. Parts (a) and (b) of FIG. 2 are equivalent circuit diagrams of the image forming apparatuses, wherein (a) is the equivalent circuit diagram in this embodiment and (b) is the equivalent circuit diagram in a conventional embodiment shown in FIG. 6. FIG. 7 is a schematic view for illustrating a structure of the image forming apparatus in this embodiment. Incidentally, in these figures, constituents having the same functions as those shown in FIG. 5 are represented by the same reference numerals or symbols.

With reference to FIG. 7, an image forming apparatus 1 in this embodiment will be described. Here, as an example of the image forming apparatus 1, a laser beam printer using a transfer type electrophotographic process will be described. A reference numeral 3 represents a rotation drum type photosensitive member as an image bearing member and is a photosensitive drum rotatable clockwise at a predetermined peripheral speed. An outer peripheral surface of the photosensitive drum 3 during rotation is electrically charged uniformly by a charging roller 4 as a charging means. The charged photosensitive drum 3 is exposed to laser light L outputted from a laser beam scanner 5 as an image exposure means, so that an electrostatic latent image is formed. This electrostatic latent image is developed into a toner image with toner as a developer by a developing device 6 as a developing means. A recording material 108 as a material to be heated is separated and fed one by one from a feeding cassette 7 by a feeding roller 8 and then is sent to a registration roller pair 10 through a conveying roller pair 9. The registration roller pair 10 conveys the recording material 108 to a transfer nip N, in order to dispose the toner image at a predetermined position of the recording material 108 (with respect to a conveyance direction), so as to synchronize the recording material 108 with the toner image formed on the photosensitive drum 3. The recording material 108 is nip-conveyed in the transfer nip N and is conveyed to a heat-fixing device 2 according to the present invention by a transfer roller 602, to which a transfer bias of an opposite polarity to a toner charge polarity is applied, while receiving the toner image transferred from the photosensitive drum 3. By the heat-fixing device 2, the toner image is heat-fixed on the recording material 108 and the recording material 108 is then discharged onto a discharge tray 13 through a discharging roller pair 12.

The image heating device (heat-fixing device 2) in this embodiment will be described with reference to (a) and (b) of FIG. 1. The heat-fixing device 2 includes a heater 100 as a heat generating member, a heater holder 105, a fixing film 106 and a pressing roller 107 as a pressing member. The heater holder 105 has rigidity and heat resistance and supports, as a heat generating member supporting member, the heater 100. The fixing film 106 has the heat resistance and flexibility and is a sleeve-like member which moves in contact with the heater 100 at its one surface. The pressing roller 107 includes an elastic layer and is press-contacted to the other surface of the fixing film 106 and is rotated while press-contacting the fixing film 106 hermetically against the heater 100.

The heater 100 includes an elongated thin plate-like heater substrate 102 formed with a ceramic material such as alumina, a heat generating resistor 103 for generating heat by energization, and an electroconductive member 109 for supplying power from a commercial power source to the heat generating resistor 103. On the heater substrate 102, an area in which the heat generating resistor 103 is formed is coated (covered) with a coating glass (insulating layer) 104 for insulating the commercial power source voltage applied to the heat generating resistor 103. The heater 103 is supported by the heater holder 105 by engaging the heater substrate 102 in a groove provided at a lower surface (opposing the pressing roller 107) of the heater holder 105. The groove in which the heater substrate 102 is to be engaged is formed so that a longitudinal direction of the engaged heater substrate 102 coincides with a direction perpendicular to the conveyance direction of the recording material 108. The heat resistant fixing film 106 moves while being press-contacted hermetically to the exposed surface of the heater 100 by the pressing roller 107 including the elastic layer. By such a pressing constitution, a fixing nip N is formed between the pressing roller 107 and the fixing film 106 contacted to the heater 100. In the fixing nip N, the recording material 108 on which an unfixed toner image is formed and carried is conveyed. The unfixed toner image is fixed on a surface of the recording material 108 by applying heat of the heat generating resistor 103 to the recording material 108 through the fixing film 106. The constitution described above is the same as that of the heater in the conventional embodiment shown in FIG. 5.

A difference of the heater in this embodiment from the heater in conventional embodiment will be described. An electroconductive pattern (electroconductive layer) 109 formed of an electroconductive material such as silver is disposed above and in parallel to the heater substrate 102 through the heat generating resistor 103 and the coating glass (insulating layer) 104. Further, on the electroconductive pattern 101, the same material as the coating glass 104 is coated, so that the electroconductive pattern 101 is insulated and thus glass is contacted to the fixing film 106. By forming the respective layers in this way, the electroconductive layer 104 is provided at a position which is located between the heat generating resistor 103 and a fixing film 106-side surface of the insulating layer (coating glass) 104 and is remote from the heat generating resistor 103 and the fixing film 106-side surface of the insulating layer 104.

In this embodiment, a portion of the coating glass 104 between the heat generating resistor 103 and the electroconductive pattern 101 corresponds to a first insulating layer contacted to the heat generating resistor 103. A portion of the coating glass 104 contacted to the fixing film 106 at an outer side more than the electroconductive pattern 101 corresponds to a second insulating layer contacted to the fixing film 106. That is, the heater 100 in this embodiment includes these (first and second) insulating layers formed of the coating glass 104 and includes the electroconductive layer of the electroconductive pattern 101 formed between the first insulating layer and the second insulating layer.

With reference to FIGS. 2 and 6, a circuit structure of the image forming apparatus in this embodiment will be described. The circuit structure of the image forming apparatus in this embodiment is different from that in the conventional embodiment shown in FIG. 6. Constitutions other than the constitution of the image heating device are the same as those described in the conventional embodiment with reference to FIG. 6 and therefore will be omitted from description. Here, a difference from the constitution shown in FIG. 6 will be described. First, in the conventional embodiment, the fixing nip (fixing film 106) is connected to the ground potential but in this embodiment, the electroconductive pattern 101 is connected to the ground potential. Further, in the conventional embodiment, the fixing nip (fixing film 106) is connected to the ground via the resistor 608 and the capacitor 609 but in this embodiment, the electroconductive pattern 101 is grounded via only the resistor 608. That is the constitution in this embodiment is different from that in the conventional embodiment in that the grounded portion of the image heating device shown in FIG. 6 is changed from the fixing nip (fixing film 106) to the electroconductive layer (electroconductive pattern 101) between the heat generating resistor 103 and the recording material 108 and that the capacitor 609 is eliminated.

With reference to (a) and (b) of FIG. 2, the equivalent circuit diagram of the image forming apparatus in this embodiment will be described. In this embodiment, the heat generating resistor 103 and the electroconductive pattern 101 are capacitively coupled, and the electroconductive pattern (electroconductive layer) 101 and the recording material 108 are capacitively coupled. A capacitive component C_{G1} is formed between the heat generating resistor 103 and the electroconductive pattern 101 via the coating glass 104, and a capacitive component C_{G2} is formed between the electroconductive pattern (electroconductive layer) 101 and the recording material 108 via the coating glass 104. In this embodiment, the coating glass 104 has a thickness of 60 μm at the portion C_{G1} and 10 μm at the portion C_{G2} and has a capacitance value of 250 pF for C_{G1} and 1500 pF for C_{G2}. A reference symbol Rₚ represents a resistor of the recording material 108 extending between the fixing nip N and the transfer nip T and its resistance value is about 120 MΩ in a high temperature/high humidity environment. A reference symbol Rₜ represents a resistor of the transfer roller 602, and a reference symbol C_{S} represents a stray capacitor component from a shaft of the transfer roller 602 to the ground potential. In this embodiment, Rₜ has a resistance value of 150 MΩ, and C_{S} has a capacitance value of 10 pF. A reference symbol R_{b} represents a resistor (element having impedance) added in this embodiment and has a resistance value of 1 MΩ in this embodiment.

To the transfer nip T, the AC voltage is transmitted from the commercial power source through the coating glass. A fluctuation in the transfer nip N by the AC voltage at this time is determined by impedance Z1 of C_{G1} and a ratio between joint impedance Z3 of C_{G2}, Rₚ, Rₜ and C_{S} and impedance Z4 of the added circuit for reducing the fluctuation in the transfer nip T. It is possible to reduce the voltage fluctuation in the transfer nip T by making the impedance Z4, i.e., joint impedance from the electroconductive layer 101 to the ground smaller than the impedance Z3, i.e., the joint impedance from the electroconductive layer 101 to the ground via the recording material and the transfer portion. Particularly, the impedance Z4 may preferably be set at a value which is 1/10 or less of that of the impedance Z3. The transfer nip fluctuation can be obtained from joint impedance Z2 of the transfer roller. Here, these joint impedances are determined according to the following formulas.

$$\begin{matrix}Z 1 = j \frac{1}{2 π fCG 1} & formula 1 \\ Z 3 = ( Rp + Rt ) + j ( \frac{1}{2 π fCG 2} + \frac{1}{2 π fCs} ) & formula 2 \\ Z 4 = Rb & formula 3 \\ Z 2 = Rt + j \frac{1}{2 π fCs} & formula 4\end{matrix}$$

Absolute values of these joint impedances are determined according to the following formulas.

$$\begin{matrix}Z 1 = \frac{1}{2 π fCG 1} & formula 5 \\ Z 3 = \sqrt{{( Rp + Rt )}^{2} + {( \frac{1}{2 π fCG 2} + \frac{1}{2 π fCs} )}^{2}} & formula 6 \\ Z 4 = Rb & formula 7 \\ Z 2 = \sqrt{{Rt}^{2} + {( \frac{1}{2 π fCs} )}^{2}} & formula 8\end{matrix}$$

Incidentally, the joint impedances at the respective portions in the conventional embodiment as shown in (b) of FIG. 2 are determined according to the following formulas.

$$\begin{matrix}Z 1 = \frac{1}{2 π fCG } & 9 \\ Z 3 = \sqrt{{( Rp + Rt )}^{2} + {( \frac{1}{2 π fCs} )}^{2}} & formula 10 \\ Z 4 = \sqrt{{Rb}^{2} + {( \frac{1}{2 π fCb} )}^{2}} & formula 11 \\ Z 2 = {Rt}^{2} + {( \frac{1}{2 π fCs} )}^{2} & formula 12\end{matrix}$$

Based on these formulas, when the respective impedances are calculated, Z4=1 MΩ, Z1=10 MΩ, Z3=380 MΩ and Z2=300 MΩ are obtained, and an attenuation factor of the AC voltage in the transfer nip (=(AC voltage applied to transfer nip T)/(AC voltage applied to heat generating member 103)×100(%)) is about 7%. Incidentally, also in the conventional embodiment, the attenuation factor of the AC voltage in the transfer nip is also calculated as about 7%. For this reason, compared with the conventional embodiment in which the resistor R_{b} and the capacitor C_{b} are added, according to this embodiment, it is found that a similar effect is obtained by adding only the resistor R_{b}. That is, according to the present invention, it becomes possible to suppress the transfer voltage fluctuation, caused by the commercial power source, with an inexpensive constitution. Incidentally, the number of added resistors may be one as in this embodiment or may also be two or more.

### Embodiment 2

With reference to FIG. 3, Embodiment 2 of the present invention will be described. Parts (a) and (b) of FIG. 3 are schematic views showing an image heating device in this embodiment. Here, only a difference from Embodiment 1 will be described. Constitutions which are not described in this embodiment are the same as those in Embodiment 1. The difference of this embodiment from Embodiment 1 is in that the heat generating resistor 103 is formed on a back surface of a heater substrate 302 and an electroconductive pattern (electroconductive layer) 301 is disposed in parallel to the heat generating resistor 103 via the heater substrate 302. A coating layer (insulating layer) 303 for improving a sliding property on the fixing film 106 is formed of a polyimide-based material in many cases. That is, the heater in this embodiment includes, the heater substrate 302, the heat generating resistor 103 provided on the heater substrate 302, the insulating layer 303 provided on the heater substrate 302 at a surface opposite from the back surface where the heat generating resistor 103 is provided, and the heater is contacted to the fixing film 106 at the insulating layer 303 side.

In this embodiment, different from Embodiment 1, the member interposed between the heat generating resistor 103 and the electroconductive pattern 301 (101) is changed from the coating glass 104 to the heater substrate 302. As a result, compared with Embodiment 1, the electrostatic capacitance between the heat generating resistor 103 and the electroconductive pattern 301 becomes small to increase the impedance Z1, so that it becomes possible to decrease the attenuation factor in the fixing nip. Further, compared with the coating glass 104, a voltage resistant property of the heater substrate 302 is high and therefore it is possible to improve resistance to dielectric breakdown in the case where a serge voltage due to, e.g., lightning is applied to the commercial power source.

In this embodiment, the heater substrate 302 corresponds to the first insulating layer contacted to the heat generating resistor. Further, the coating layer 303 which coats an area in which the electroconductive pattern 301 is formed on the heater substrate 302 corresponds to the second insulating layer contacted to the fixing film. That is, the heater in this embodiment includes the first insulating layer consisting of the heater substrate 302, the electroconductive layer consisting of the electroconductive pattern 301 and the second insulating layer consisting of the coating layer. Incidentally, with respect to the equivalent circuit in this embodiment, the constitution is the same as that of the equivalent circuit in Embodiment 1 except that the electrostatic capacitance is different and therefore will be omitted from illustration and description.

### Embodiment 3

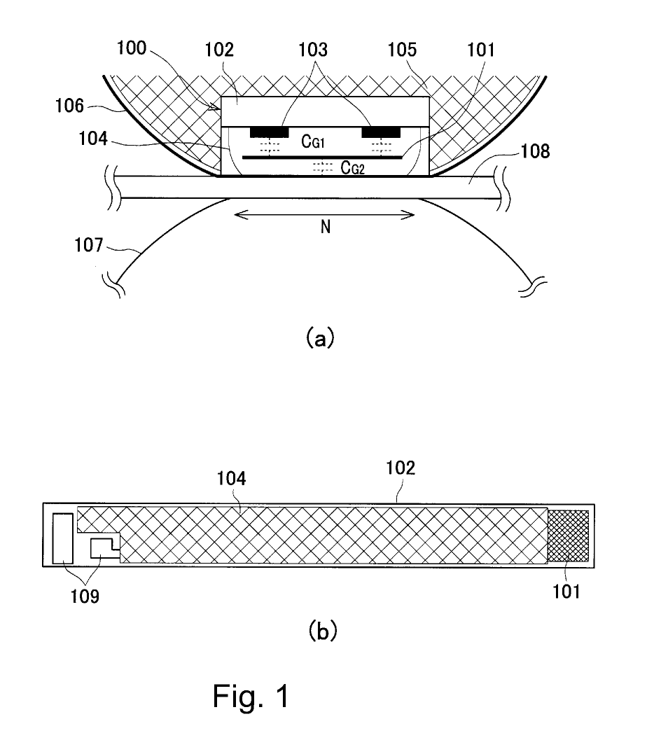

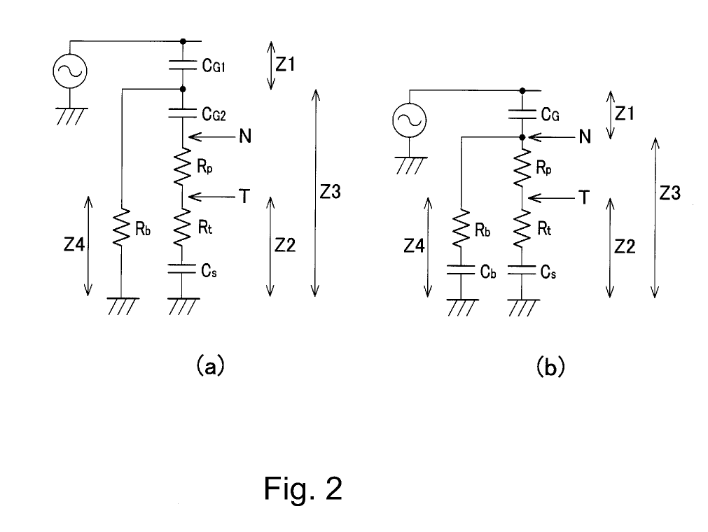

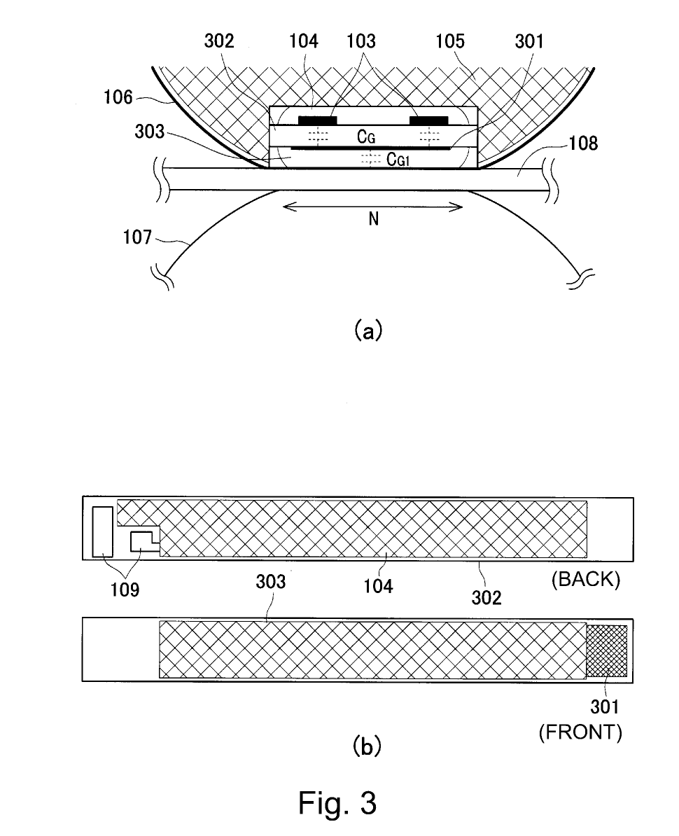

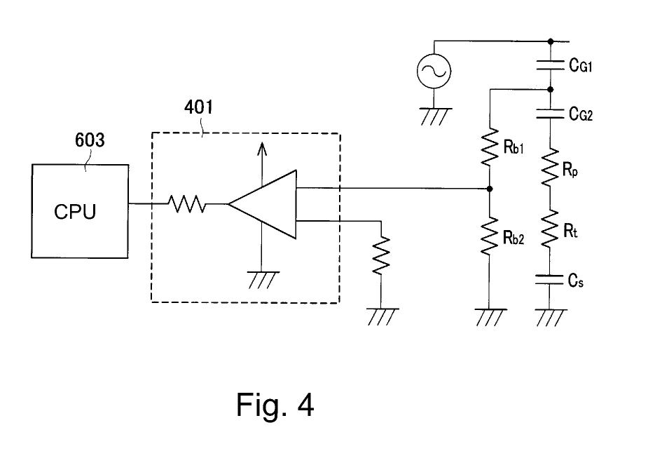

With reference to FIG. 4, Embodiment 3 of the present invention will be described. FIG. 4 is an equivalent circuit diagram showing Embodiment 3 and also a schematic view showing a constitution for detecting fluctuation of the commercial power source. Here, only a difference from Embodiment 1 will be described. Constitutions which are not described in this embodiment are the same as those in Embodiment 1. The difference of this embodiment from Embodiment 1 is in that a detecting circuit 401, constituted by a comparator, a resistor and the like, for detecting the fluctuation in AC voltage of the commercial power source is provided. An input portion of the detecting circuit 401 is capacitively could with resistors R_{b1} and R_{b2} by the coating glass C_{G1}, so that a fluctuation waveform depending on the fluctuation factor determined by an impedance ratio among R_{b1}, R_{b2} and C_{G1} is inputted into the input portion. That is, the detecting circuit 401 is constituted so that it can detect a change in voltage generated in the resistors R_{b1} and R_{b2} in proportion to the fluctuation in AC voltage of the commercial power source.

In the conventional commercial power source detecting circuit, an optical semiconductor such as a photocoupler was generally used for detecting ripples before rectification, so that consumption current for turning on an LED of the photocoupler was required. According to this embodiment, the detecting portion of the commercial power source is constituted by the capacitor and the resistor and therefore compared with the detecting portion using the photocoupler, it becomes possible to reduce consumption power of the circuit and the number of parts of the detecting circuit. That is, according to this embodiment, it becomes possible to simultaneously suppress, with a simple constitution, the fluctuation in transfer voltage caused by the commercial power source and the consumption power of the conventional commercial power source detecting circuit using the photocoupler or the like.

Incidentally, in this embodiment, as an example of the detecting circuit, the comparator is used but there is no problem even when another circuit structure using a device other than the comparator if the circuit structure is capable of detecting the fluctuation in inputted waveform. Further, the insulating property between the commercial power source and the detecting circuit is ensured by the coating glass and the resistors and thus there is no problem.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 127344/2010 filed Jun. 2, 2010, which is hereby incorporated by reference.

What is claimed is:

1. An image heating device comprising:
a cylindrical film;
a heater contacted to an inner surface of said film, wherein said heater includes a substrate, a heat generating resistor provided on the substrate, and an insulating layer for covering the heat generating resistor and is contacted to said film; and
a pressing member for pressing said film against said heater to form a nip, between itself and said film, in which a recording material carrying thereon an image is to be nip-conveyed,
wherein said heater includes an electroconductive layer, which is grounded, provided at a position between and remote from a film-side surface of the insulating layer and the heat generating resistor.

2. A device according to claim 1, wherein the electroconductive layer is grounded through an element having impedance.

3. A device according to claim 2, wherein said image heating device is mounted in an image forming apparatus including a transfer portion at which the image is to be transferred onto the recording material, and
wherein a joint impedance Z4 from the electroconductive layer to ground is smaller than a joint impedance Z3 from the electroconductive layer to ground through the recording material and the transfer portion.

4. A device according to claim 2, further comprising a detecting circuit for detecting a fluctuation of an AC voltage of a commercial power source by detecting a change in voltage generated in the element by the fluctuation of the AC voltage of the commercial power source for supplying power to the heat generating resistor.

5. A heater comprising:
a substrate;
a heat generating resistor provided on said substrate;
an insulating layer for covering said heat generating resistor; and
an electroconductive layer provided at a position between and remote from a surface of said insulating layer and said heat generating resistor.

6. An image heating device comprising:
a cylindrical film;
a heater contacted to an inner surface of said film, wherein said heater includes a substrate, a heat generating resistor provided on the substrate, and an insulating layer provided on the substrate at a surface opposite from a surface at which the heat generating resistor is provided on the substrate, and is contacted to said film; and
a pressing member for pressing said film against said heater to form a nip, between itself and said film, in which a recording material carrying thereon an image is to be nip-conveyed,
wherein said heater includes an electroconductive layer, which is grounded, provided at a position the substrate and insulating layer.

7. A device according to claim 6, wherein the electroconductive layer is grounded through an element having impedance.

8. A device according to claim 7, wherein said image heating device is mounted in an image forming apparatus including a transfer portion at which the image is to be transferred onto the recording material, and
wherein a joint impedance Z4 from the electroconductive layer to ground is smaller than a joint impedance Z3 from the electroconductive layer to ground through the recording material and the transfer portion.

9. A device according to claim 7, further comprising a detecting circuit for detecting a fluctuation of an AC voltage of a commercial power source by detecting a change in voltage generated in the element by the fluctuation of the AC voltage of the commercial power source for supplying power to the heat generating resistor.

10. A heater comprising:
a substrate;
a heat generating resistor provided on said substrate;
an insulating layer provided on said substrate at a surface opposite from a surface at which said heat generating resistor is provided on said substrate; and
an electroconductive layer provided at a position between said substrate and said insulating layer.
